(19) United States
(12) Patent Application Publication
(10) Pub. No.: US 2020/0230627 A1
(43) Pub. Date: Jul. 23, 2020

(54) OSCILLATING SPRINKLER

(71) Applicant: Chin-Yuan Chen, Changhua (TW)

(72) Inventor: Chin-Yuan Chen, Changhua (TW)

(73) Assignee: Shin Tai Spurt Water of the Garden Tools Co., Ltd., Changhua (TW)

(21) Appl. No.: 16/252,894

(22) Filed: Jan. 21, 2019

(51) Int. Cl. B05B 3/16

(52) U.S. Cl. CPC B05B 3/16

(57) ABSTRACT

An oscillating sprinkler may include a main body, a water outlet tube, two moving members, a cover, and a c-shaped control ring. The main body has a connecting portion and a connecting tube respectively formed at two ends thereof, and the connecting tube is connected to a water source. The water outlet tube is cut in axial direction to form a water outlet portion, and a plurality of water outlet holes are separately formed thereon. A first elastic strip is installed in the interior of the water outlet tube, and a plurality of elastic nozzles are formed on the first elastic strip at positions corresponding to the water outlet holes.

### FIELD OF THE INVENTION

The present invention relates to a sprinkler and more particularly to an oscillating sprinkler that is easy to adjust to different water spraying angles.

### BACKGROUND OF THE INVENTION

Referring to FIGS. 10 and 11, a conventional oscillating sprinkler (60) comprises a water outlet tube (61), a sprinkling member (62), two control boards (63), and two handles (64). The water outlet tube (61) has a plurality of outlet holes (611) thereon, and a plurality of elastic nozzles (621) are configured to protrude from an outer surface of the sprinkling member (62). Each of the elastic nozzles (621) is adapted to penetrate through the outlet hole (611). Each of the control boards (63) comprises a plurality of through holes (631) thereon which are configured to dispose on the elastic nozzles (621) respectively. The two handles (64) are respectively and pivotally connected to two ends of the water outlet tube (61), and each of the two handles (64) is pivotally connected at an outer surface of the control board (63) through an axle (641). Also, each of the handles (64) has a locating plane (642). When the spraying angle of elastic nozzles (621) needs to be adjusted, a user can pull the two handles (64) outwardly so as to enable the axles (641) to pull and move the control boards (63) outwardly. At this time, the through holes (631) of the control boards (63) are configured to push the elastic nozzles (621) so as to change the spraying angle of the elastic nozzles (621). After pulled, the handles (64) are secured as the locating planes (642) of the handles (64) abut against an outer surface of the water outlet tube (61).

However, the conventional oscillating sprinkler has following disadvantages: (i) a user needs to use two hands to pull the two handles (64) so as to adjust the spraying angle; and (ii) the handles (64) can only secure at a position that the locating planes (642) abut against the water outlet tube (61), and when the user release the handles (64), the elastic nozzles (621) are configured to push the handles (64) back to theirs initial positions, which makes the oscillating sprinkler (60) to only have single spraying angle. Therefore, there remains a need for a new and improved design for an oscillating sprinkler to overcome the problems presented above.

### SUMMARY OF THE INVENTION

The present invention provides an oscillating sprinkler which comprises a main body, a water outlet tube, two moving members, a cover, and a c-shaped control ring. The main body has a connecting portion and a connecting tube respectively formed at two ends thereof, and the connecting tube is connected to a water source. The water outlet tube is connected to the connecting portion of the main body at a first end thereof, and a second end of the water outlet tube is connected to the connecting tube so as to enable water to flow into an interior of the water outlet tube. The water outlet tube is cut in axial direction to form a water outlet portion, and a plurality of water outlet holes are separately formed thereon. A first elastic strip is installed in the interior of the water outlet tube, and a plurality of elastic nozzles are formed on the first elastic strip at positions corresponding to the water outlet holes, and the elastic nozzles are configured to outwardly protrude through the water outlet holes respectively. The two moving members are arranged in parallel in the water outlet portion of the water outlet tube, and each of the moving members has a plurality of first holes separately formed thereon, and the first holes are respectively penetrated through by the elastic nozzles. Each of the moving members comprises an oblique slot formed at an end thereof close to the other moving member, and the two oblique slots are unparalleled. The cover, which has a plurality of axial elongated holes formed thereon, is configured to couple with the water outlet tube to cover and limit the moving members to slide on the water outlet tube, and the elongated holes are arranged in line along an axial direction of the cover, and the elastic nozzles are adapted to penetrate through and stand out of the elongated holes respectively. The cover has two paralleled elongated slots at a middle portion thereof, and each of the elongated slots formed perpendicular to the axial direction of the cover is partially overlapped with the oblique slot. The control ring is disposed on middle portions of the water outlet tube and the cover, and two control rods protrude from an inner surface of the control ring, and each of the control rods is adapted to penetrate through the elongated slot and the oblique slot.

In one embodiment, a knob installed on the connecting portion is connected to a connecting head, and an annular groove is formed at the first end of the water outlet tube; through rotating the knob, the connecting head is adapted to stretch out to connect to the annular groove.

In another embodiment, a driving portion installed on an end of the connecting tube is configured to control the water outlet tube to have axial rotation to a specific angle.

In still another embodiment, each of two lateral surfaces of the water outlet portion has an abutting surface, and each of the moving members has two lateral boards respectively and vertically extended from two lateral edges thereof; the two lateral boards of the moving member are coupled with the abutting surfaces respectively so as to enable the moving member to slidably couple on the water outlet tube through the lateral boards.

In a further embodiment, each of sealing members formed between the first elastic strip and the elastic nozzle is adapted to couple with the water outlet hole to achieve the positioning and leaking-proof effects.

In still a further embodiment, each of two lateral surfaces of the water outlet tube comprises a plurality of engaging slots, and each of two lateral edges of the cover has a plurality of engaging blocks protruding therefrom which are respectively engaged with the engaging slots.

In yet a further embodiment, at least a first sawtooth section is formed at an outer surface of the water outlet tube, and the inner surface of the control ring comprises at least a second sawtooth section which is configured to couple with the first sawtooth section so as to form the appropriate resistance and achieve positioning effect for the control ring.

In a particular embodiment, two ends of the c-shaped control ring are respectively coupled with two ends of a second elastic strip to form a loop, and the second elastic strip is adapted to provide an appropriate tightening force so as to enable the control ring to couple around the cover and the water outlet tube and to enable the second sawtooth section to slide on the first sawtooth section when the control ring is rotated.

In a preferred embodiment, the control ring has at least a pulling piece protruding from an outer surface thereof, and the pulling piece is configured to be pulled to rotate the control ring relative to the cover and the water outlet tube.

In an advantageous embodiment, the cover comprises a second hole formed thereon between the two elongated slots, and the control ring has a dodging slot formed between the control rods; one of the elastic nozzles only penetrates through the second hole and the dodging slot so as to enable the elastic nozzle to keep straight without pushed or moved by the moving members.

Comparing with conventional oscillating sprinkler, the present invention is advantageous because: (i) when the control rods are moved along the elongated slots to push the moving members, the elastic nozzles are configured to be pushed by the first holes so as to enable the oscillating sprinkler to achieve different angles of water spraying; and (ii) through the slidable engagement between the first sawtooth section and the second sawtooth section, the control ring is positioned at different rotating angles after rotated so as to adjust the spraying angle of the oscillating sprinkler.

### BRIEF DESCRIPTION OF THE DRAWINGS

FIG. 1 is a three-dimensional assembly view of an oscillating sprinkler of the present invention.

FIG. 2 is a three-dimensional exploded view of the oscillating sprinkler of the present invention.

FIG. 3 is a sectional view of the oscillating sprinkler of the present invention.

FIG. 4 is a sectional view along line A-A of FIG. 3.

FIG. 5 is a sectional view along line B-B of FIG. 3.

FIG. 6 is a schematic view illustrating two moving members of the oscillating sprinkler are separated in the present invention.

FIG. 7 is a schematic view illustrating the two moving members of the oscillating sprinkler are coupled side by side in the present invention.

FIG. 8 is a sectional view along line B-B illustrating the oscillating sprinkler of the present invention is operated.

FIG. 9 is a schematic view illustrating the water spraying angle of the oscillating sprinkler of the present invention is adjusted.

FIG. 10 is a prior art.

FIG. 11 is a prior art.

### DETAILED DESCRIPTION OF THE INVENTION

The detailed description set forth below is intended as a description of the presently exemplary device provided in accordance with aspects of the present invention and is not intended to represent the only forms in which the present invention may be prepared or utilized. It is to be understood, rather, that the same or equivalent functions and components may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any methods, devices and materials similar or equivalent to those described can be used in the practice or testing of the invention, the exemplary methods, devices and materials are now described.

All publications mentioned are incorporated by reference for the purpose of describing and disclosing, for example, the designs and methodologies that are described in the publications that might be used in connection with the presently described invention. The publications listed or discussed above, below and throughout the text are provided solely for their disclosure prior to the filing date of the present application. Nothing herein is to be construed as an admission that the inventors are not entitled to antedate such disclosure by virtue of prior invention.

In order to further understand the goal, characteristics and effect of the present invention, a number of embodiments along with the drawings are illustrated as following:

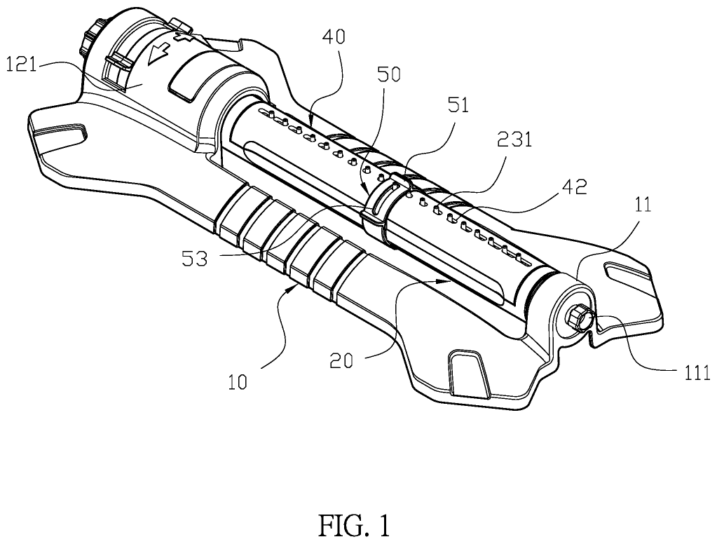

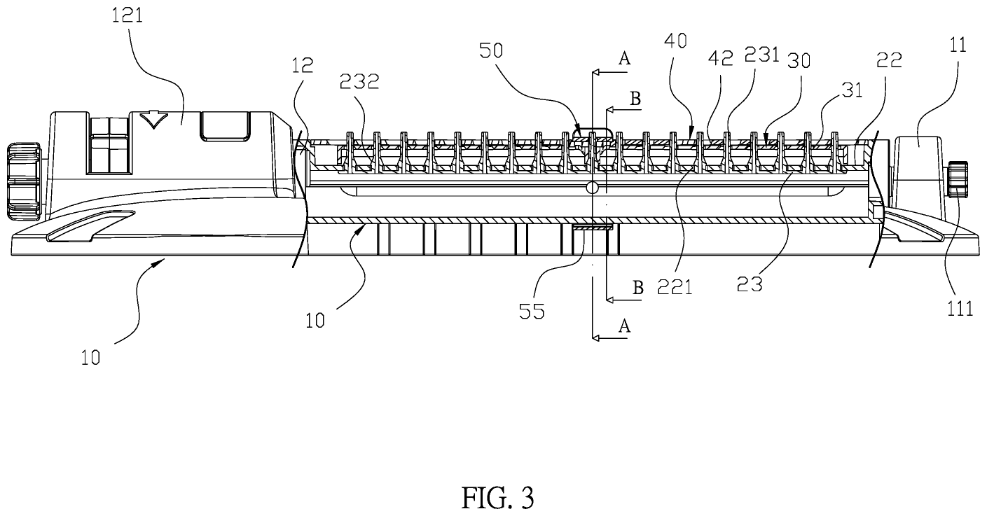

Referring to FIGS. 1 to 3, the present invention provides an oscillating sprinkler which comprises a main body (10), a water outlet tube (20), two moving members (30), a cover (40), and a c-shaped control ring (50). The main body (10) has a connecting portion (11) and a connecting tube (12) respectively formed at two ends thereof, and a knob (111) installed on the connecting portion (11) is connected to a connecting head (112). Also, a driving portion (121) installed on an end of the connecting tube (12) is configured to control the water outlet tube (20) to have axial rotation to a specific angle, and the connecting tube (12) is connected to a water source. The water outlet tube (20) is connected to the connecting portion (11) of the main body (10) at a first end thereof, and an annular groove (21) is formed at the first end of the water outlet tube (20). Furthermore, through rotating the knob (111), the connecting head (112) is adapted to stretch out to connect to the annular groove (21). A second end of the water outlet tube (20) is connected to the connecting tube (12) so as to enable water to flow into an interior of the water outlet tube (20). The water outlet tube (20) is cut in axial direction to form a water outlet portion (22), and a plurality of water outlet holes (221) are separately formed thereon. Moreover, a first elastic strip (23) is installed in the interior of the water outlet tube (20), and a plurality of elastic nozzles (231) are formed on the first elastic strip (23) at positions corresponding to the water outlet holes (221). The elastic nozzles (231) are configured to outwardly protrude through the water outlet holes (221) respectively, and each of sealing members (232) formed between the first elastic strip (23) and the elastic nozzle (231) is adapted to couple with the water outlet hole (221) to achieve the positioning and leaking-proof effects. Each of two lateral surfaces of the water outlet portion (22) has an abutting surface (24) and a plurality of engaging slots (25). The two moving members (30) are arranged in parallel in the water outlet portion (22) of the water outlet tube (20), and each of the moving members (30) has a plurality of first holes (31) separately formed thereon, and the first holes (31) are respectively disposed on the elastic nozzles (231). Each of the moving members (30) comprises an oblique slot (32) formed at an end thereof close to the other moving member (30), and the two oblique slots (32) are unparalleled. Each of the moving members (30) has two lateral boards (33) respectively and vertically extended from two lateral edges thereof, and the two lateral boards (33) of the moving member (30) are coupled with the abutting surfaces (24) respectively so as to enable the moving member (30) to slidably couple on the water outlet tube (20) through the lateral boards (33). The cover (40) is configured to couple with the water outlet tube (20) to cover and limit the moving members (30) to slide on the water outlet tube (20), and each of two lateral edges of the cover (40) has a plurality of engaging blocks (41) protruding therefrom. The engaging blocks (41) are configured to engage with the engaging slots (25) of the water outlet tube (20) respectively. Moreover, the cover (40) has a plurality of axial elongated holes (42) formed thereon, and the elongated holes (42) are arranged in line along an axial direction of the cover (40), and the elastic nozzles (231) are adapted to penetrate through and stand out of the elongated holes (42) respectively. The cover (40) has two paralleled elongated slots (43) at a middle portion thereof, and each of the elongated slots (43) formed perpendicular to the axial direction of the cover (40) is partially overlapped with the oblique slot (32). Furthermore, the cover (40) comprises a second hole (44) formed thereon between the two elongated slots (43). The control ring (50) disposed on middle portions of the water outlet tube (20) and the cover (40) has at least a pulling piece (51) protruding from an outer surface thereof, and the pulling piece (51) is configured to be pulled to rotate the control ring (50) relative to the cover (40) and the water outlet tube (20). Also, two control rods (52) protrude from an inner surface of the control ring (50), and each of the control rods (52) is adapted to penetrate through the elongated slot (43) and the oblique slot (32). In addition, the control ring (50) has a dodging slot (53) formed between the control rods (52), and one of the elastic nozzles (231) only penetrates through the second hole (44) and the dodging slot (53) so as to enable the elastic nozzle (231) to keep straight without pushed or moved by the moving members (30). Moreover, the control ring (50) is rotated along the elongated slots (53), and through the oblique slots (32), the control rods (52) are configured to synchronously move the two moving members (30) close to or away from each other, and the first hole (31) of the moving member (30) is adapted to tilt the elastic nozzle (231) so as to adjust spraying angle of the oscillating sprinkler. Additionally, at least a first sawtooth section (26) is formed at an outer surface of the water outlet tube (20), and the inner surface of the control ring (50) comprises at least a second sawtooth section (54) which is configured to couple with the first sawtooth section (26) so as to form the appropriate resistance and achieve positioning effect for the control ring (50). Furthermore, two ends of the c-shaped control ring (50) are respectively coupled with two ends of a second elastic strip (55) to form a loop, and the second elastic strip (55) is adapted to provide an appropriate tightening force so as to enable the control ring (50) to couple around the cover (40) and the water outlet tube (20) and to enable the second sawtooth section (54) to slide on the first sawtooth section (26) when the control ring (50) is rotated. Also, through the slidable engagement between the first sawtooth section (26) and the second sawtooth section (54), the control ring (50) is positioned at different rotating angles after rotated so as to adjust the spraying angle of the oscillating sprinkler.

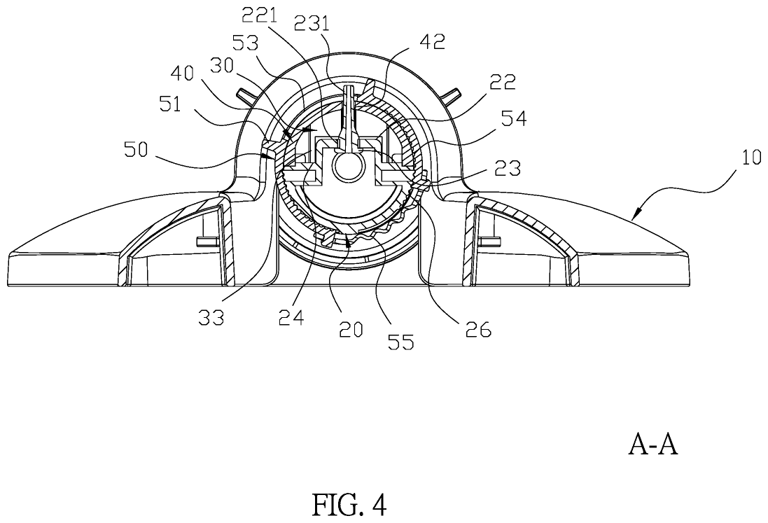

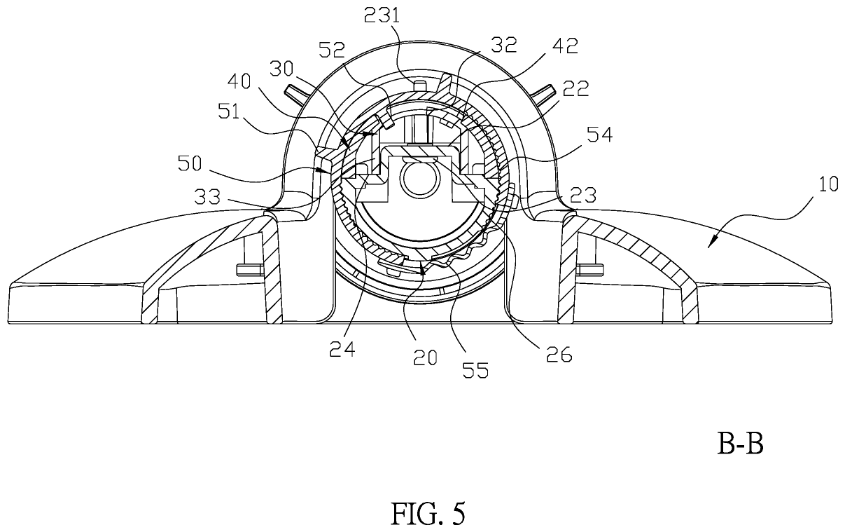

Structurally, referring to FIGS. 1 to 5, the first elastic strip (23) is installed in the interior of the water outlet tube (20), and the elastic nozzles (231) are configured to respectively and outwardly penetrate through the water outlet holes (221) so as to enable the sealing members (232) of the first elastic strip (23) to abut against the water outlet holes (221) respectively. The two moving members (30) are positioned side by side on the water outlet portion (22) of the water outlet tube (20), and the lateral boards (33) of the moving member (30) are respectively coupled with the two abutting surfaces (24). The first holes (31) are respectively disposed on the elastic nozzles (231). The cover (40) is adapted to couple and cover the water outlet tube (20), and the engaging blocks (41) of the cover (40) are engaged with the engaging slots (25) of the water outlet tube (20) such that the cover (40) is configured to and limit the moving members (30) to slide on the water outlet tube (20). Also, the elastic nozzles (231) are configured to outwardly and respectively penetrate through the elongated holes (42) and the second hole (44), and the control ring (50) is disposed on the middle sections of the cover (40) and the water outlet tube (20). The two ends of the c-shaped control ring (50) are respectively coupled with the two ends of the second elastic strip (55) to form a loop, and the second elastic strip (55) is adapted to provide an appropriate tightening force so as to enable the control ring (50) to couple around the cover (40) and the water outlet tube (20). The two control rods (52) of the control ring (50) respectively penetrate through the two elongated slots (43) and the two oblique slots (32), and the dodging slot (53) is penetrated through by the elastic nozzle (231) which penetrates through the second hole (44). The second sawtooth section (54) of the control ring (50) is coupled with the first sawtooth section (26) of the water outlet tube (20). The water outlet tube (20) is positioned on the main body (10), and the annular groove (21) formed at the first end of the water outlet tube (20) is coupled with the connecting portion (11) of the main body (11), and the second end of the water outlet tube (20) is connected to the connecting tube (12).

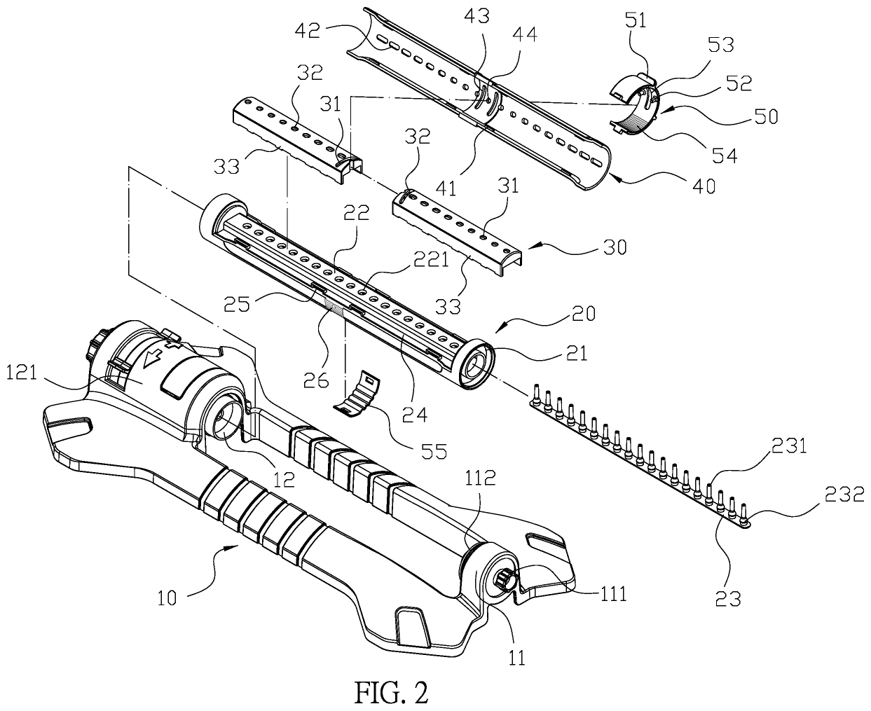

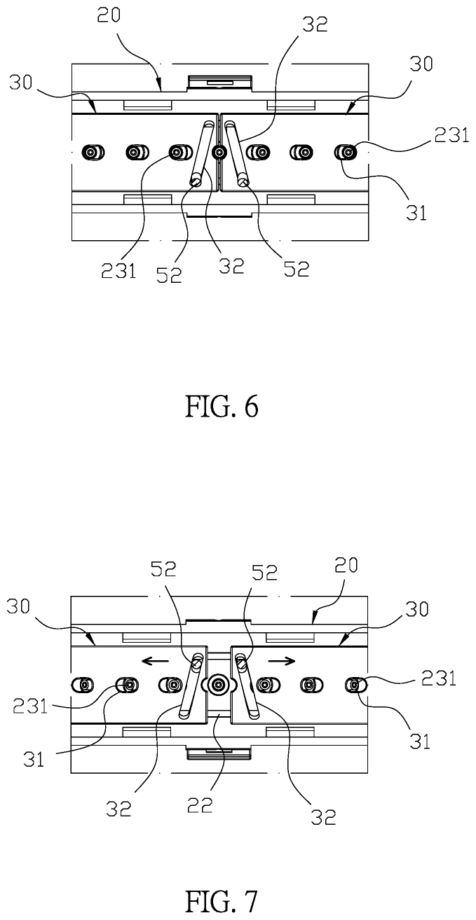

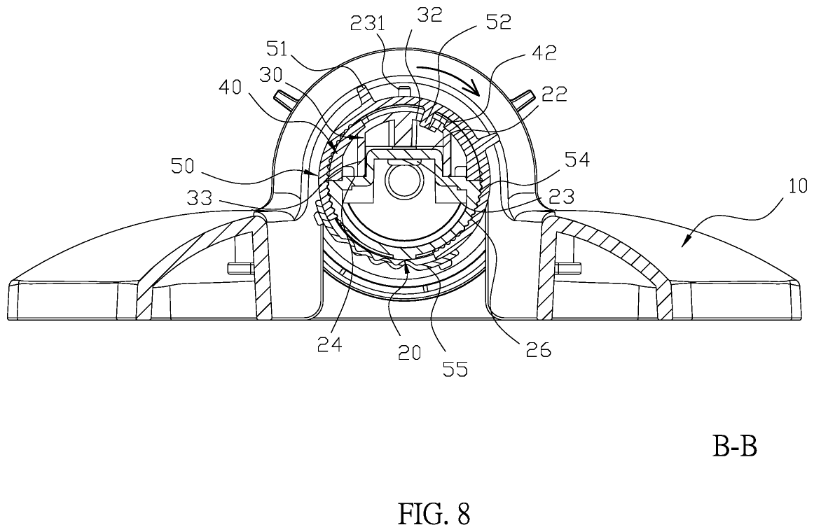

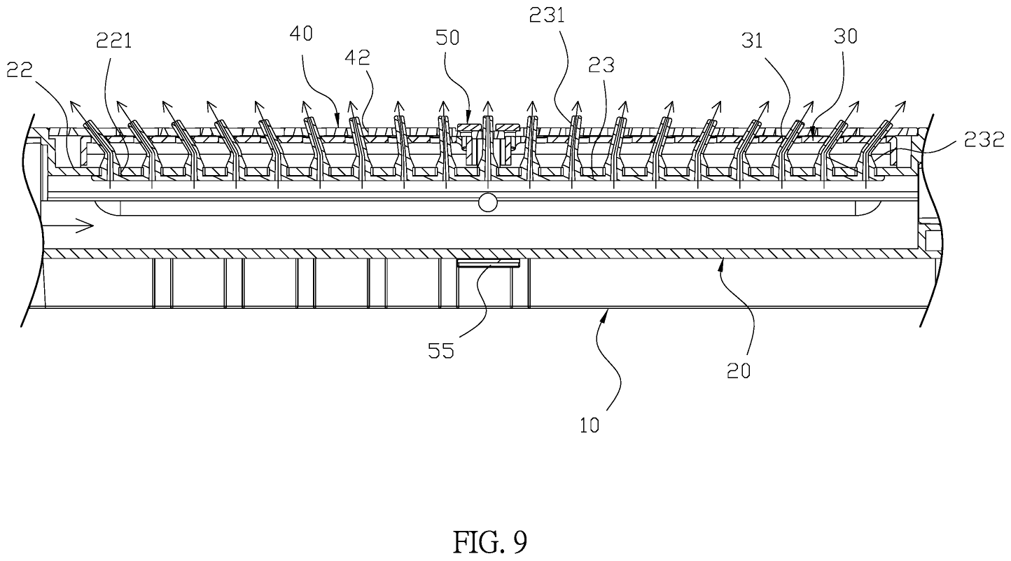

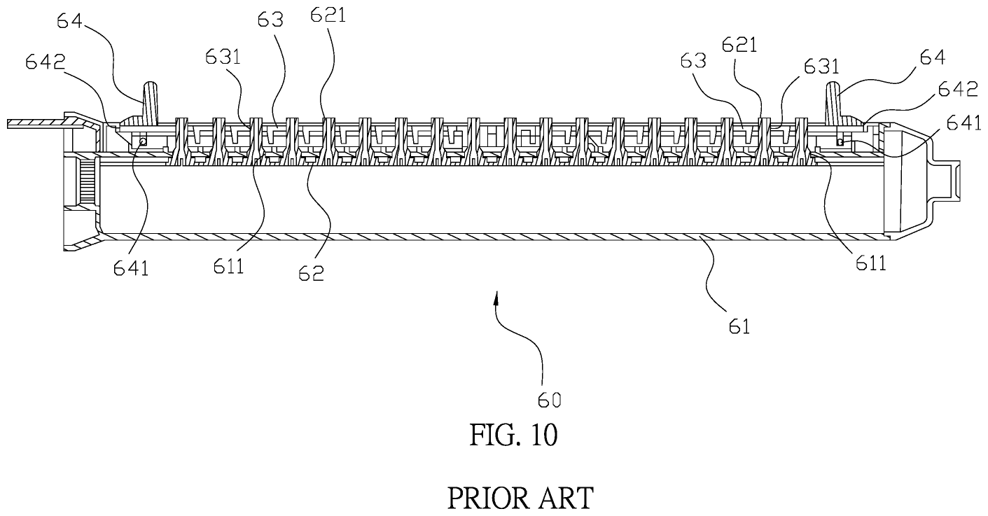

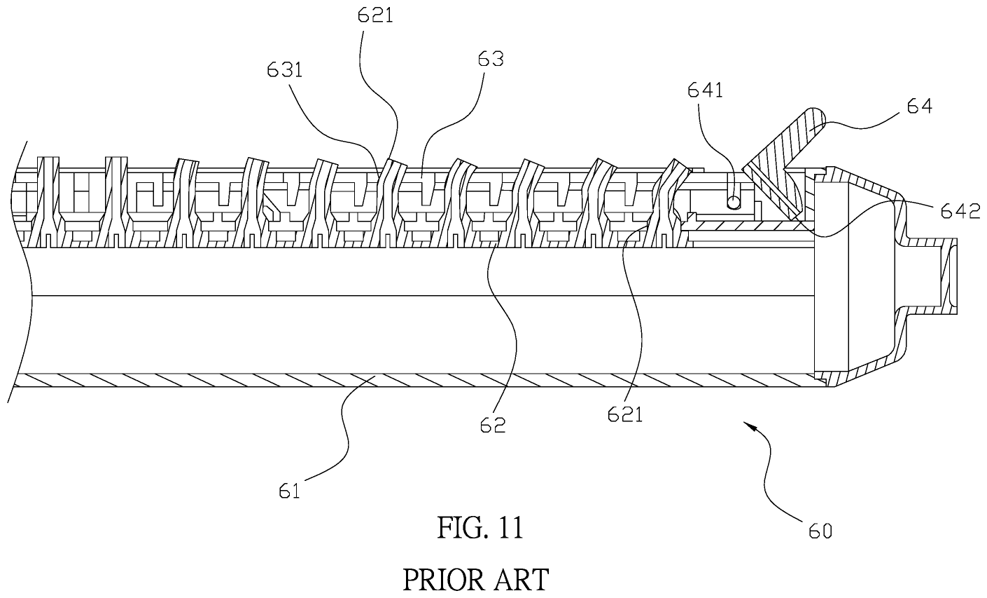

In actual application, referring to FIGS. 2 and 5 to 9, the connecting tube (12) of the main body (10) is connected to water source, and the main body (10) is positioned at a place which needs to water spraying. Water is configured to flow into the water outlet tube (20) and spray out from the elastic nozzles (231) of the first elastic strip (23). The driving portion (121) of the main body (10) is adapted to drive and rotate the water outlet tube (20) to a specific angle so as to enable the water outlet tube (20) to achieve large area water spraying. When the water spraying angle of the oscillating sprinkler of the present invention needs to be adjusted, a user can pull the pulling piece (51) to rotate the control ring (50) relative to the water outlet tube (20) and the cover (40) to a specific angle. At this moment, the control rods (52) are respectively moved along the elongated slots (43) of the cover (40) so as to push the oblique slots (32). When the control rods (52) are moved along the elongated slots (43) to push the moving members (30) coupled together, the elastic nozzles (231) are not pushed by the first holes (31) and positioned straight up at a vertical spraying angle. When the moving members (30) are pushed by the control rods (52) to separate from each other, the elastic nozzles (231) are configured to be pushed by the first holes (31) and bent at a specific angle so as to enable the oscillating sprinkler of the present invention to achieve different angles of water spraying. Moreover, the outer surface of the water outlet tube (20) has at least one first sawtooth section (26), and the control ring (50) comprises at least one second sawtooth section (54) at the inner surface thereof which is adapted to engage with the first sawtooth section (26) so as to form the appropriate resistance and achieve positioning effect for the control ring (50). Thus, through the slidable engagement between the first sawtooth section (26) and the second sawtooth section (54), the control ring (50) is positioned at different rotating angles after rotated so as to adjust the spraying angle of the oscillating sprinkler.

Having described the invention by the description and illustrations above, it should be understood that these are exemplary of the invention and are not to be considered as limiting. Accordingly, the invention is not to be considered as limited by the foregoing description, but includes any equivalents.

What is claimed is:

1. An oscillating sprinkler comprising,
a main body having a connecting portion and a connecting tube respectively formed at two ends thereof, and the connecting tube connected to a water source;
a water outlet tube connected to the connecting portion of the main body at a first end thereof, and a second end of the water outlet tube connected to the connecting tube so as to enable water to flow into an interior of the water outlet tube; the water outlet tube cut in axial direction to form a water outlet portion, and a plurality of water outlet holes separately formed thereon; a first elastic strip installed in the interior of the water outlet tube, and a plurality of elastic nozzles formed on the first elastic strip at positions corresponding to the water outlet holes, and the elastic nozzles configured to outwardly protrude through the water outlet holes respectively;
two moving members arranged in parallel in the water outlet portion of the water outlet tube, and each of the moving members having a plurality of first holes separately formed thereon, and the first holes respectively penetrated through by the elastic nozzles; each of the moving members comprising an oblique slot formed at an end thereof close to the other moving member, and the two oblique slots being unparalleled;
a cover, which has a plurality of axial elongated holes formed thereon, configured to couple with the water outlet tube to cover and limit the moving members to slide on the water outlet tube, and the elongated holes arranged in line along an axial direction of the cover, and the elastic nozzles adapted to penetrate through and stand out of the elongated holes respectively; two paralleled elongated slots formed at a middle portion of the cover, and each of the elongated slots, which is formed perpendicular to the axial direction of the cover, partially overlapped with the oblique slot; and
a c-shaped control ring disposed on middle portions of the water outlet tube and the cover, and two control rods protruding from an inner surface of the control ring, and each of the control rods adapted to penetrate through the elongated slot and the oblique slot; the control rods moved along the elongated slots to push the moving members, and the elastic nozzles configured to be pushed by the first holes so as to achieve different angles of water spraying.

2. The oscillating sprinkler of claim 1, wherein a knob installed on the connecting portion is connected to a connecting head, and an annular groove is formed at the first end of the water outlet tube; through rotating the knob, the connecting head is adapted to stretch out to connect to the annular groove.

3. The oscillating sprinkler of claim 1, wherein a driving portion installed on an end of the connecting tube is configured to control the water outlet tube to have axial rotation to a specific angle.

4. The oscillating sprinkler of claim 1, wherein each of two lateral surfaces of the water outlet portion has an abutting surface, and each of the moving members has two lateral boards respectively and vertically extended from two lateral edges thereof; the two lateral boards of the moving member are coupled with the abutting surfaces respectively so as to enable the moving member to slidably couple on the water outlet tube through the lateral boards.

5. The oscillating sprinkler of claim 1, wherein each of sealing members formed between the first elastic strip and the elastic nozzle is adapted to couple with the water outlet hole to achieve the positioning and leaking-proof effects.

6. The oscillating sprinkler of claim 1, wherein each of two lateral surfaces of the water outlet tube comprises a plurality of engaging slots, and each of two lateral edges of the cover has a plurality of engaging blocks protruding therefrom which are respectively engaged with the engaging slots.

7. The oscillating sprinkler of claim 1, wherein at least a first sawtooth section is formed at an outer surface of the water outlet tube, and the inner surface of the control ring comprises at least a second sawtooth section which is configured to couple with the first sawtooth section so as to form the appropriate resistance and achieve positioning effect for the control ring.

8. The oscillating sprinkler of claim 7, wherein two ends of the c-shaped control ring are respectively coupled with two ends of a second elastic strip to form a loop, and the second elastic strip is adapted to provide an appropriate tightening force so as to enable the control ring to couple around the cover and the water outlet tube and to enable the second sawtooth section to slide on the first sawtooth section when the control ring is rotated.

9. The oscillating sprinkler of claim 1, wherein the control ring has at least a pulling piece protruding from an outer surface thereof, and the pulling piece is configured to be pulled to rotate the control ring relative to the cover and the water outlet tube.

10. The oscillating sprinkler of claim 1, wherein the cover comprises a second hole formed thereon between the two elongated slots, and the control ring has a dodging slot formed between the control rods; one of the elastic nozzles only penetrates through the second hole and the dodging slot so as to enable the elastic nozzle to keep straight without pushed or moved by the moving members.
